(19) United States
(12) Patent Application Publication
(10) Pub. No.: US 2026/0148174 A1
(43) Pub. Date: May 28, 2026

(54) Adaptive Modular System and Method for AI-Driven Professional Evaluation and Benchmarking

(71) Applicant: Kevin Neal, Coral Gables, FL (US)

(72) Inventor: Kevin Neal, Coral Gables, FL (US)

(21) Appl. No.: 18/961,180

(22) Filed: Nov. 26, 2024

(51) Int. Cl. G06Q 10/0639; G06F 16/25; G06F 21/64; G06N 20/00

(52) U.S. Cl. CPC G06Q 10/06398; G06F 16/254; G06F 21/64; G06N 20/00

(57) ABSTRACT

This invention relates to an adaptive modular system and method for professional evaluation and benchmarking across multiple industries. The system integrates advanced artificial intelligence and machine learning algorithms within a modular framework to provide personalized, objective, and real-time assessments. Key components include a data ingestion layer for collecting data from diverse sources, a data processing engine for cleaning and transforming data, a feature extraction module, a machine learning module comprising various models, evaluation modules tailored to specific assessment criteria, an adaptive algorithm controller employing reinforcement learning, and a user interface layer. The system addresses limitations in existing evaluation methods by offering dynamic customization, scalability, efficient data processing, and enhanced personalization. It leverages techniques such as natural language processing, deep learning, explainable AI, and continuous learning to deliver comprehensive evaluations, benchmark performance against industry standards, and support decision-making processes.

### BACKGROUND OF THE INVENTION

### Field of Invention

The present invention relates to systems and methods for professional evaluation and benchmarking that employ advanced machine learning algorithms and artificial intelligence to provide real-time, personalized assessments. Specifically, it introduces a technical framework comprising a modular, adaptive evaluation system designed to objectively assess, rank, and benchmark professionals across various industries, including but not limited to financial services, legal services, and accounting. The invention addresses technical challenges in customizing evaluation criteria dynamically, processing complex data inputs efficiently, and delivering accurate benchmarking results through innovative computational techniques.

### BRIEF SUMMARY OF THE INVENTION

The present invention provides a technical solution to the challenges of objectively evaluating and benchmarking professionals across various industries by introducing an adaptive modular framework that utilizes advanced machine learning algorithms and artificial intelligence (AI) for real-time, personalized assessments. This invention addresses the technical problems associated with static evaluation systems, limited data processing capabilities, lack of personalization, and underutilization of AI technologies in existing professional evaluation methods.

### Technical Overview of the Invention

The invention comprises a computer-implemented system and method that integrates adaptive algorithms within a modular architecture to deliver real-time professional evaluations. The system is designed to process large volumes of heterogeneous data, including quantitative performance metrics and qualitative assessments, using advanced AI and machine learning techniques. It enables dynamic customization of evaluation criteria based on user-defined inputs and industry-specific requirements, providing objective and personalized assessments.

### Key Technical Features

Adaptive Modular Architecture: The system is built on a modular framework that allows for the addition, removal, or modification of evaluation modules corresponding to different assessment criteria. Each module represents a specific aspect of professional performance (e.g., client satisfaction, regulatory compliance, financial metrics). The modular design facilitates scalability and adaptability, enabling the system to cater to multiple industries and evolving professional standards.

Machine Learning Algorithms for Personalization: The invention employs supervised and unsupervised machine learning models to analyze user preferences and adjust evaluation criteria accordingly. Algorithms such as neural networks, decision trees, or clustering algorithms are utilized to identify patterns in user interactions and prioritize assessment factors based on individual needs. This personalization enhances the relevancy and effectiveness of the evaluations provided.

Real-Time Data Processing and Analysis: Advanced data processing techniques are implemented to handle and analyze large datasets efficiently. The system utilizes optimized data structures and parallel processing methods to achieve real-time performance. This includes processing streaming data inputs and updating evaluations instantaneously, which is critical for timely decision-making in professional contexts.

Continuous Learning and Adaptation: The machine learning models within the system are designed to learn from new data continuously. The system updates its algorithms and evaluation criteria based on the accumulation of data over time, incorporating emerging industry trends, best practices, and performance metrics. This continuous learning capability ensures that the evaluations remain current and accurate.

Objective Benchmarking and Ranking: The invention provides objective benchmarking by comparing individual professional performance against up-to-date industry standards and peer data. Statistical analysis and predictive modeling techniques are used to generate accurate rankings and identify areas for improvement. This feature assists users in making informed decisions based on quantifiable data.

### Technical Advantages Over Prior Art

Dynamic Customization versus Static Frameworks: Unlike prior art that relies on fixed evaluation criteria, this invention offers dynamic customization through adaptive algorithms. The system can modify evaluation parameters in real-time, addressing the technical problem of inflexibility in traditional systems.

Advanced AI Integration: The incorporation of advanced machine learning models for personalization and continuous learning is a significant advancement over existing systems that underutilize AI technologies. This technical feature enables deeper insights and more accurate assessments.

Efficient Data Processing Capabilities: The system addresses scalability and performance issues present in prior art by employing optimized computational methods. Techniques such as parallel processing, in-memory computing, and efficient data indexing contribute to high-performance data handling.

Modular and Scalable Architecture: The modular design allows the system to adapt to different industries and user requirements seamlessly. This contrasts with monolithic systems in prior art that lack flexibility and scalability.

### Non-Obviousness and Novelty

The invention's combination of a modular framework with adaptive machine learning algorithms for real-time professional evaluation and benchmarking is non-obvious to those skilled in the art. While individual components such as evaluation systems or machine learning algorithms are known, their integration in the manner described to solve the specific technical problems is novel. The inventive step lies in the synergistic effect achieved by combining these components to create a flexible, personalized, and continuously improving evaluation system.

### Detailed Implementation of AI and Machine Learning Components

Data Acquisition and Preprocessing: The system collects data from various sources, including internal databases, third-party providers, and user inputs. Data preprocessing steps such as normalization, encoding categorical variables, and handling missing values are performed to prepare the data for analysis.

Feature Engineering: Relevant features are extracted and engineered to enhance the performance of machine learning models. This may include creating composite metrics, transforming variables, or selecting significant attributes based on statistical tests.

Model Training and Selection: Multiple machine learning models are trained using historical data. Techniques such as cross-validation, grid search, and ensemble methods are employed to select the optimal model for each evaluation module. Models are evaluated based on performance metrics like accuracy, precision, recall, and F1-score.

Adaptive Algorithms: The system utilizes reinforcement learning algorithms to adjust evaluation criteria dynamically. Feedback mechanisms allow the system to learn from user interactions and outcomes, updating the weightings of different assessment factors accordingly.

System Architecture: The architecture includes components such as a data ingestion layer, processing engine, machine learning models, and user interface. The processing engine coordinates data flow and computations, while the machine learning models perform analysis and generate evaluation results. Cloud-based infrastructure and distributed computing techniques are leveraged for scalability and reliability.

Security and Compliance: The system implements security protocols to protect sensitive data, including encryption, access controls, and compliance with data protection regulations such as GDPR or HIPAA where applicable.

### Use Case Scenario

For example, in the financial services industry, a user may require an evaluation that emphasizes regulatory compliance and client portfolio performance. The system allows the user to input these preferences, and the adaptive algorithms adjust the evaluation criteria by increasing the weighting of relevant modules. The machine learning models analyze real-time data on regulatory filings, transaction records, and market performance to generate an objective assessment. The system then benchmarks the professional's performance against industry peers, providing actionable insights.

### Sufficient Disclosure and Enablement

The detailed description of the system architecture, algorithms, and data processes ensures that a person skilled in the art can implement the invention without undue experimentation. Specific embodiments and examples are provided to illustrate how the components interact and function collectively to achieve the technical objectives. The disclosure includes information on the selection and training of machine learning models, data processing methodologies, and system integration techniques.

### Industrial Applicability

The invention is applicable across multiple professional industries where objective evaluation and benchmarking are critical. By addressing technical challenges in data processing, personalization, and adaptive evaluations, the system enhances decision-making processes for clients, organizations, and professionals alike.

The present invention offers a technical solution to the limitations of existing professional evaluation systems by introducing an adaptive modular framework that leverages advanced machine learning and AI technologies. It provides objective, personalized, and real-time assessments that are scalable and adaptable to various industries. Through detailed implementation of AI components and a novel integration of adaptive algorithms within a modular architecture, the invention achieves improvements in efficiency, accuracy, and relevancy of professional evaluations, representing a significant advancement over prior art.

### BRIEF DESCRIPTION OF THE FIGURES

FIG. 1 illustrates stages of a benchmarked evaluation report according to an embodiment of the present invention

FIGS. 2A-F illustrate the suite of dashboards and summary tools within the Point93 BenchmarkEval System.

FIG. 3 illustrates the operation of an adaptive algorithm controller.

FIG. 4 illustrates a data ingestion and processing workflow.

FIG. 5 illustrates a sequence of real-time data processing and continuous learning.

FIG. 6 illustrates key components in embodiments of the present invention.

FIG. 7 demonstrates the process of extracting relevant features from the processed data.

FIG. 8 illustrates a machine learning module.

FIG. 9 is a schematic representation of the evaluation modules.

FIG. 10 illustrates industry standards, peer performance data, and historical evaluation results.

FIG. 11: is a block diagram of the security and compliance module.

### DETAILED DESCRIPTION OF THE INVENTION

The present invention provides a comprehensive system and method for professional evaluation and benchmarking across various industries by employing an adaptive modular framework integrated with advanced artificial intelligence (AI) and machine learning (ML) algorithms. This detailed description outlines the technical implementation of the invention, including system architecture, data processing methodologies, machine learning components, and specific embodiments that enable objective, personalized, and real-time assessments of professionals.

### I. System Architecture Overview

The invention comprises a computer-implemented system that includes the following key components:
Data Ingestion Layer: Responsible for collecting data from multiple sources.
Data Processing Engine: Processes and transforms raw data into structured formats suitable for analysis.
Feature Extraction Module: Extracts relevant features from processed data for use in machine learning models.
Machine Learning Models: Includes supervised and unsupervised learning algorithms for evaluation and personalization.
Evaluation Modules: Modular units corresponding to different assessment criteria.
Adaptive Algorithm Controller: Adjusts evaluation criteria and model parameters dynamically based on user inputs and feedback.
User Interface Layer: Allows users to interact with the system, input preferences, and view evaluation results.
Benchmarking Database: Stores industry standards, peer performance data, and historical evaluation results.
Security and Compliance Module: Ensures data protection and regulatory compliance.

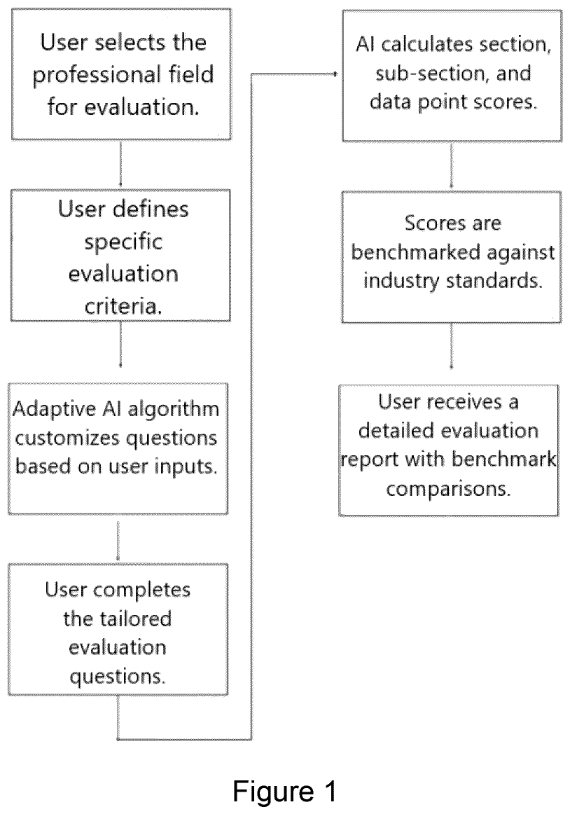

FIG. 1 illustrates the system architecture and the interaction between components, including the seven-step process of the Point93 BenchmarkEval System, detailing the stages from initial field selection through to the delivery of a comprehensive, benchmarked evaluation report.

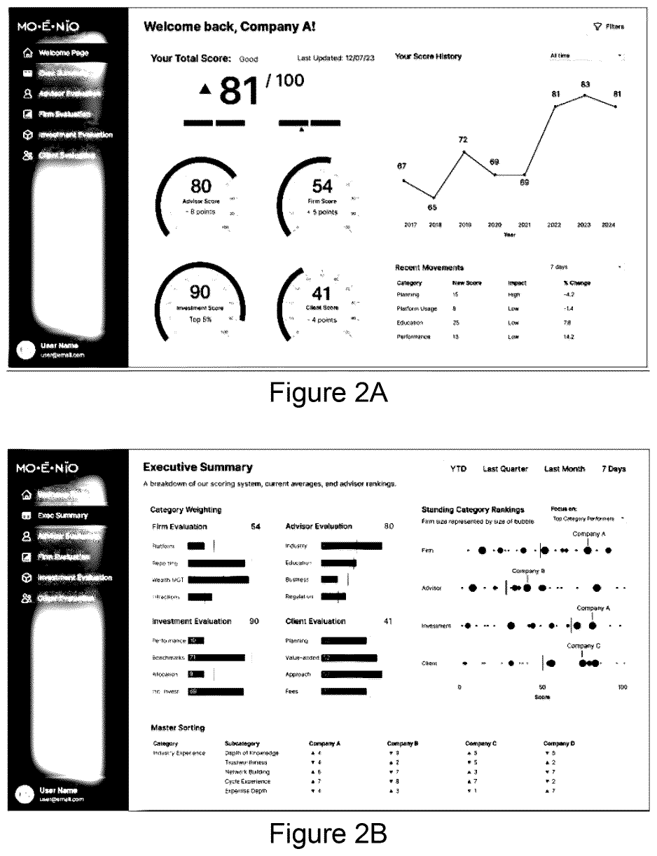

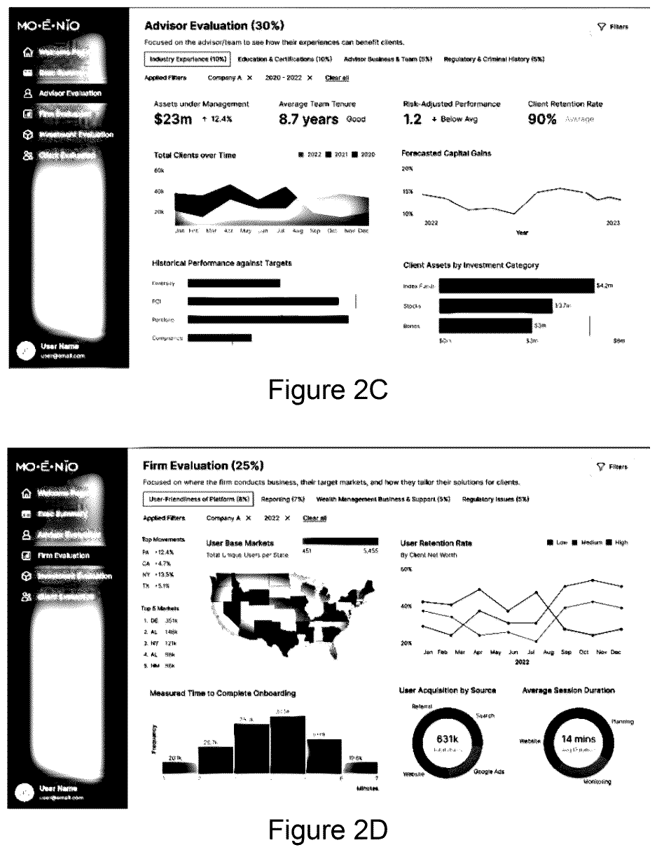

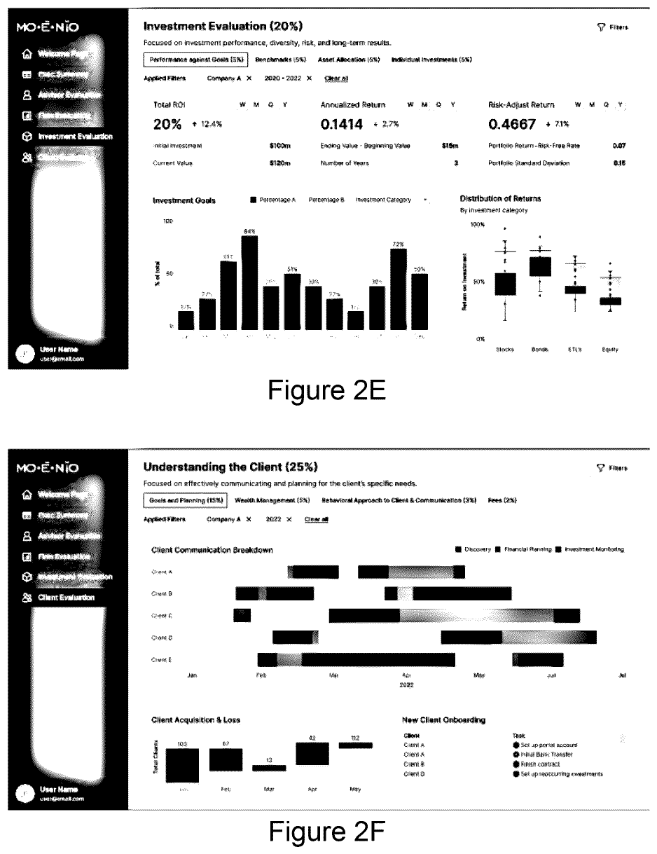

FIG. 2A-F: illustrates the suite of dashboards and summary tools within the Point93 BenchmarkEval System, including score overviews, executive summaries, and detailed evaluations of financial advisors, firms, investments, and client characteristics, enabling comprehensive performance tracking and analysis.

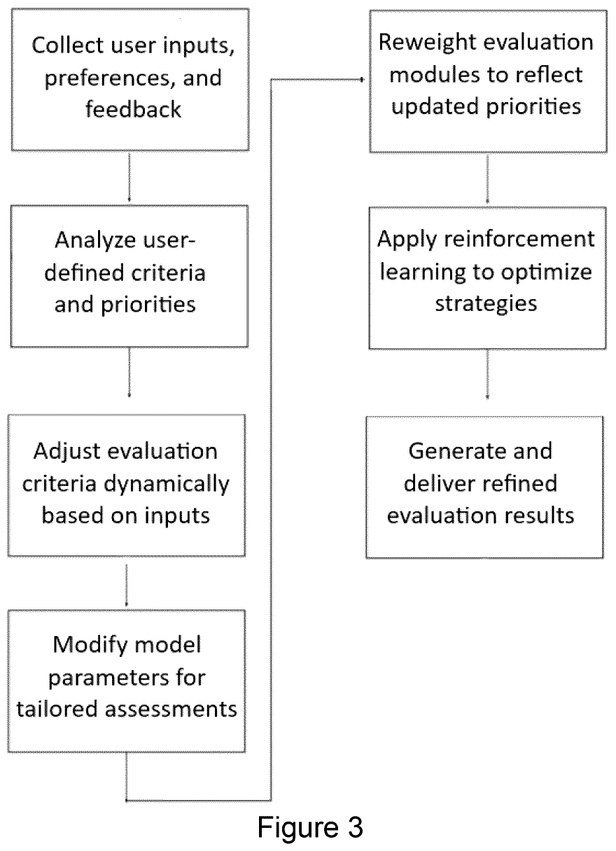

FIG. 3 illustrates the operation of the adaptive algorithm controller through a seven-step process that dynamically adjusts evaluation criteria, model parameters, and module weightings, leveraging reinforcement learning to optimize evaluation strategies and deliver refined results.

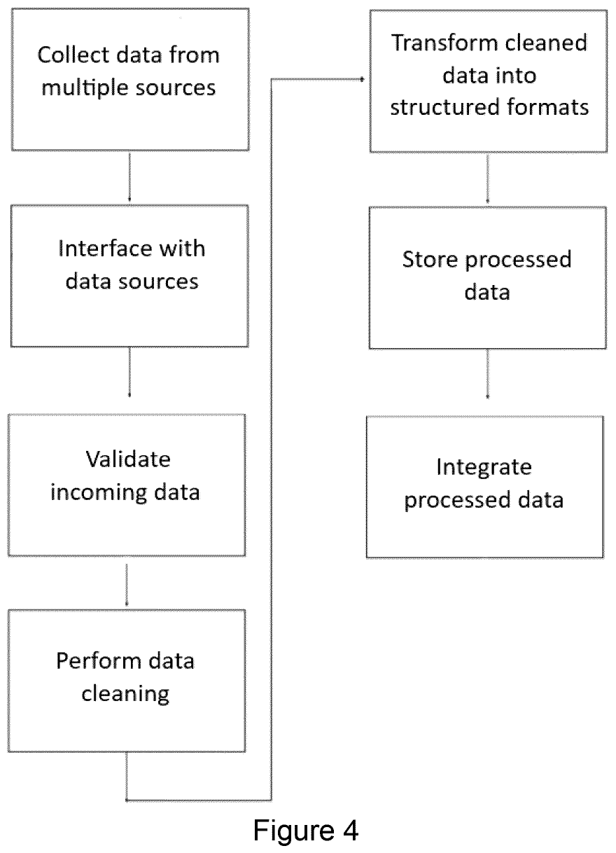

FIG. 4 illustrates the data ingestion and processing workflow, detailing the steps for collecting data from multiple sources, validating and cleaning it, transforming it into structured formats, and integrating it into the evaluation modules for real-time analysis and benchmarking.

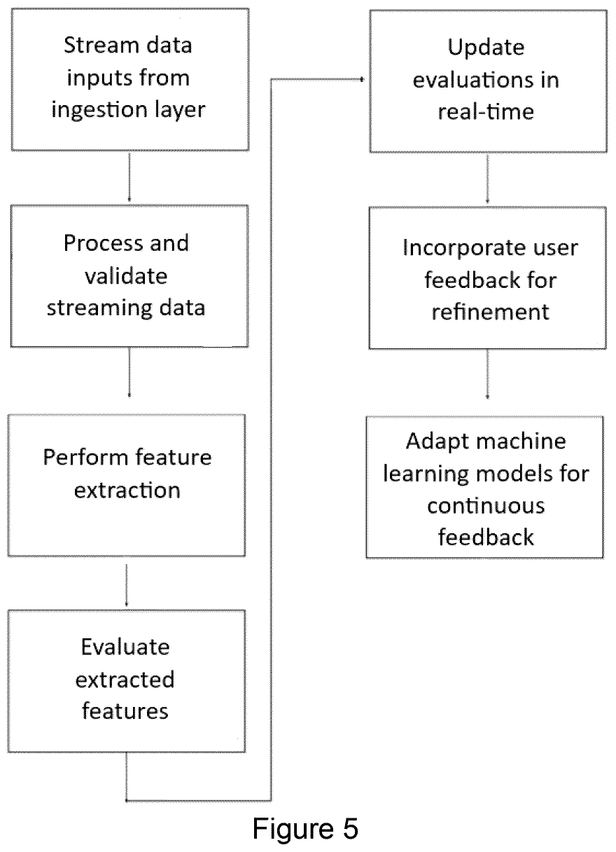

FIG. 5 illustrates the sequence of real-time data processing and continuous learning, from data ingestion and feature extraction to real-time evaluation updates and machine learning model adaptation based on streaming inputs and user feedback.

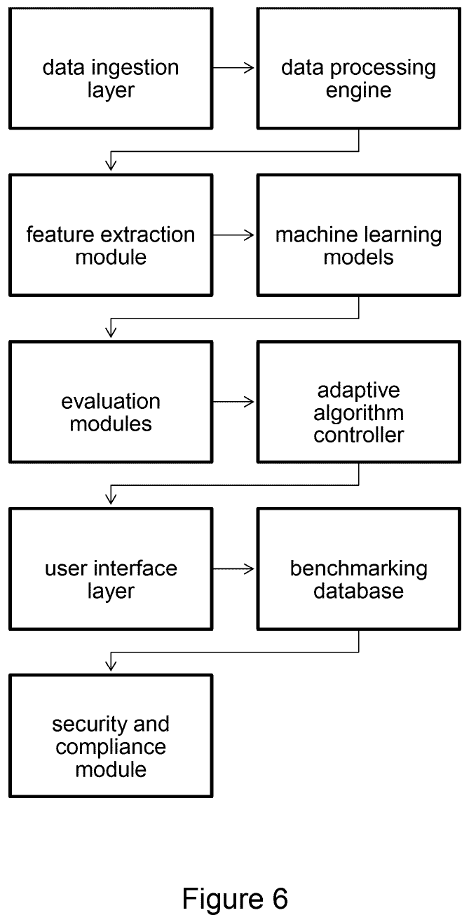

FIG. 6: is a block diagram illustrating the overall system architecture of the adaptive modular professional evaluation and benchmarking system in accordance with an embodiment of the present invention. It shows the key components, including the data ingestion layer, data processing engine, feature extraction module, machine learning models, evaluation modules, adaptive algorithm controller, user interface layer, benchmarking database, and security and compliance module, and how they interact with each other to provide real-time, personalized evaluations.

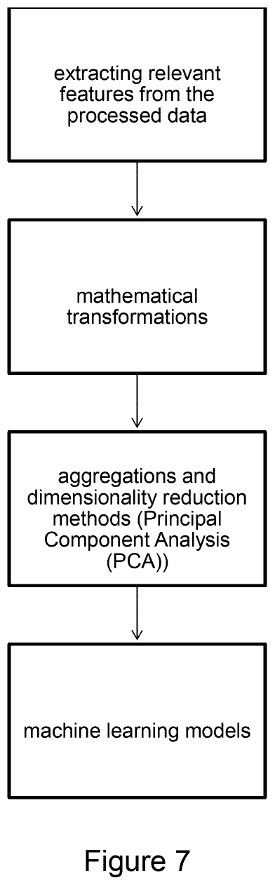

FIG. 7: is a schematic diagram of the feature extraction module. It demonstrates the process of extracting relevant features from the processed data, including feature engineering techniques such as mathematical transformations, aggregations, and dimensionality reduction methods like Principal Component Analysis (PCA). The diagram highlights how relevant features are selected for use in the machine learning models.

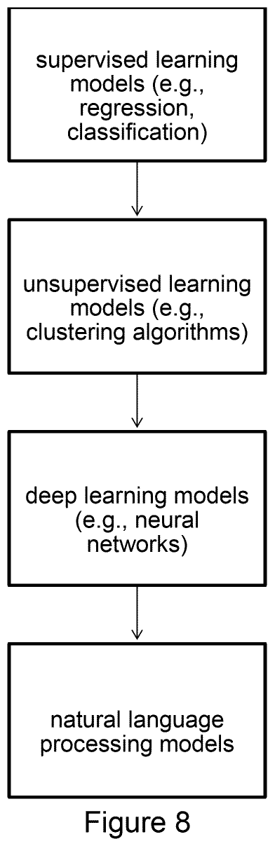

FIG. 8: is a block diagram illustrating the machine learning module. It depicts various types of machine learning models employed in the system, including supervised learning models (e.g., regression, classification), unsupervised learning models (e.g., clustering algorithms), deep learning models (e.g., neural networks), and natural language processing models. The figure shows how these models are trained using the extracted features and used for predictive assessments and pattern recognition.

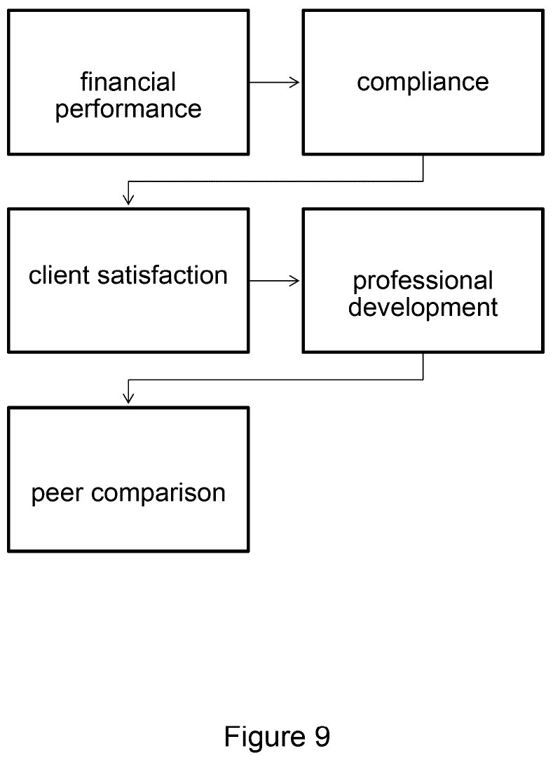

FIG. 9: is a schematic representation of the evaluation modules. It outlines the modular structure where each evaluation module corresponds to a specific assessment criterion, such as financial performance, compliance, client satisfaction, professional development, and peer comparison. The figure shows how each module leverages specific machine learning models and algorithms tailored to its criterion to perform evaluations.

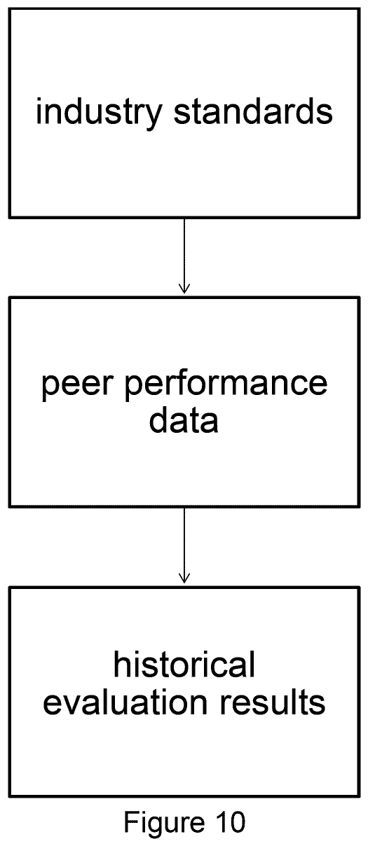

FIG. 10: is a diagram depicting the architecture of the benchmarking database. It illustrates how industry standards, peer performance data, and historical evaluation results are stored, managed, and accessed by the evaluation modules. The diagram highlights the use of structured databases, indexing, and query optimization for efficient data retrieval.

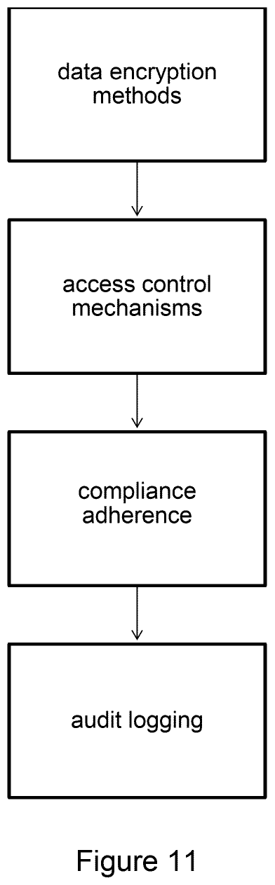

FIG. 11: is a block diagram of the security and compliance module. It highlights the data protection mechanisms implemented in the system, including data encryption methods, access control mechanisms, compliance adherence, and audit logging. The diagram shows how these features work together to ensure data security and regulatory compliance.

### II. Data Ingestion and Processing

### A. Data Sources

The system acquires data from various internal and external sources, including:
Internal Databases: Organizational records, performance metrics, client feedback.
External Databases: Industry benchmarks, regulatory filings, market data.
User Inputs: Preferences, priorities, custom evaluation criteria.
Third-Party APIs: Real-time data feeds, news, social media sentiment analysis.

### B. Data Ingestion Layer

Utilizes APIs, web scraping tools, and ETL (Extract, Transform, Load) processes to collect data. Implements data validation checks to ensure data integrity.

### C. Data Processing Engine

Data Cleaning: Removal of duplicates, correction of errors, handling missing values using techniques such as imputation.

Data Transformation: Normalization of numerical data, encoding of categorical variables using methods like one-hot encoding, label encoding.

Data Integration: Merging data from different sources based on common identifiers.

### D. Feature Extraction Module

Feature Engineering: Creation of new features by combining or transforming existing ones, such as calculating growth rates, risk-adjusted returns.

Dimensionality Reduction: Techniques like Principal Component Analysis (PCA) to reduce feature space and eliminate multicollinearity.

Selection of Relevant Features: Using statistical tests (e.g., ANOVA, Chi-squared test) and feature importance scores from models to select significant variables.

### III. Machine Learning Components

### A. Supervised Learning Models

Used for predictive assessments and scoring.

Regression Models: Linear Regression, Lasso, and Ridge Regression for continuous outcomes.

Classification Models: Decision Trees, Random Forests, Support Vector Machines (SVM), Gradient Boosting Machines (e.g., XGBoost) for categorical outcomes.

### B. Unsupervised Learning Models

Used for pattern detection and segmentation.

Clustering Algorithms: K-Means, Hierarchical Clustering, DBSCAN for grouping similar professionals based on performance metrics.

Anomaly Detection: Identifying outliers in performance data using methods like Isolation Forest.

### C. Deep Learning Models

For complex pattern recognition in large datasets.

Neural Networks: Feedforward Neural Networks for predictive modeling.

Recurrent Neural Networks (RNNS): For time-series analysis of performance data.

Convolutional Neural Networks (CNNs): If incorporating image data (e.g., graphs, charts).

### D. Natural Language Processing (NLP) Models (140D)

Analyzing textual data from client feedback, reviews, or regulatory documents.

Text Classification: Using algorithms like Naïve Bayes, Logistic Regression.

Sentiment Analysis: Utilizing pre-trained models or custom lexicons.

Topic Modeling: Latent Dirichlet Allocation (LDA) for discovering topics in documents.

### IV. Adaptive Algorithm Controller

This component adjusts the evaluation criteria and ML model parameters dynamically.

### A. Reinforcement Learning

Implements algorithms like Q-learning or Policy Gradient Methods to optimize evaluation strategies based on user feedback.

### B. User Preference Integration

Weight Adjustment: Modifies the importance of different evaluation modules based on user inputs.

Preference Learning: Uses models to predict user preferences over time and adjust assessments accordingly.

### C. Feedback Mechanisms

Explicit Feedback: Users rate the relevance of evaluation results.

Implicit Feedback: Analyzes user interactions, such as time spent on certain sections, to infer preferences.

### V. Evaluation Modules

Each module represents specific assessment criteria with associated algorithms.

### A. Financial Performance Module

Metrics: ROI, revenue growth, cost efficiency.

Models: Time-series forecasting, risk modeling.

### B. Compliance Module

Metrics: Regulatory filings, audit results.

Models: Rule-based systems, anomaly detection.

### C. Client Satisfaction Module

Metrics: Survey scores, retention rates.

Models: Sentiment analysis, churn prediction.

### D. Professional Development Module

Metrics: Training hours, certifications, skill assessments.

Models: Competency mapping, knowledge graphs.

### E. Peer Comparison Module

Metrics: Industry benchmarks, peer performance data.

Models: Clustering, ranking algorithms

### VI. Real-Time Data Processing and Analysis

### A. Parallel Processing Techniques

Distributed Computing: Utilizing frameworks like Apache Hadoop or Spark for handling big data.

In-Memory Computing: Speeds up data processing by storing data in RAM.

### B. Stream Processing

Real-Time Data Handling: Using tools like Apache Kafka or Flink to process streaming data.

Event-Driven Architecture: Reacts to data changes immediately, updating evaluations in real-time.

### VII. User Interface Layer

### A. Web-Based Dashboard

Visualization Tools: Interactive charts, graphs, and tables using libraries like D3.js or Plotly.

Customization Options: Settings for users to adjust evaluation parameters.

### B. Reporting Features

Detailed Reports: Generates comprehensive evaluation reports in various formats (PDF, Excel).

Alerts and Notifications: Sends updates via email, SMS, or in-app messages.

### VIII. Benchmarking Database

### A. Data Storage

Structured Storage: SQL databases for relational data.

NoSQL Databases: For unstructured data like documents or JSON objects.

### B. Data Retrieval

Query Optimization: Indexing and caching strategies to improve data retrieval speeds.

API Services: Exposing data retrieval functions for internal use.

### IX. Security and Compliance Module

### A. Data Protection

Encryption: AES-256 encryption for data at rest and TLS/SSL for data in transit.

Access Control: Role-Based Access Control (RBAC), Multi-Factor Authentication (MFA).

### B. Regulatory Compliance

GDPR Compliance: Data anonymization, consent management.

Industry-Specific Regulations: FINRA for financial services, HIPAA for healthcare.

### X. Specific Embodiments and Examples

### Example 1: Financial Advisor Evaluation

A financial services firm uses the system to evaluate its advisors.

Data Collected: Transaction records, client portfolio performance, compliance logs, client feedback.

Personalization: The firm prioritizes regulatory compliance and client satisfaction.

### Process

The system adjusts the weighting of the Compliance Module and Client Satisfaction Module.

Machine learning models analyze patterns of compliance breaches and client feedback sentiments.

Real-time evaluations are generated, highlighting areas of risk and opportunities for improvement.

Outcome: Advisors receive personalized feedback, the firm identifies training needs, and regulatory risks are mitigated.

### Example 2: Legal Professional Benchmarking

A law firm utilizes the system to benchmark its lawyers against industry standards.

Data Collected: Case outcomes, billable hours, client testimonials, peer reviews.

Personalization: Emphasis on case success rates and client retention.

### Process

Evaluation Modules focus on Professional Development Module (150D) and Client Satisfaction Module.

NLP models analyze case documents for complexity and success factors.

Benchmarking against peer data identifies top performers and those needing support.

Outcome: The firm enhances its competitive position, improves client services, and fosters professional growth.

### XI. Technical Advantages Over Prior Art

### A. Novel Integration of Modular Architecture with AI

Prior Art Limitation: Existing systems lack dynamic adaptability and integration of advanced AI.

Innovation: The invention's modular design allows for real-time customization, and AI models provide personalized, continuously improving evaluations.

### B. Scalability and Performance

Prior Art Limitation: Inability to process large datasets efficiently.

Innovation: Utilization of distributed computing and optimized algorithms ensures scalability without sacrificing performance.

### C. Enhanced Personalization

Prior Art Limitation: One-size-fits-all evaluations.

Innovation: Machine learning models adapt to individual user preferences and industry requirements, providing tailored assessments.

### D. Continuous Learning Capability

Prior Art Limitation: Static evaluation criteria that become outdated.

Innovation: The system's adaptive algorithms enable it to learn from new data, keeping evaluations current.

### XII. Sufficient Disclosure and Enablement

The detailed system architecture, data processing methods, machine learning techniques, and specific embodiments provide sufficient information for those skilled in the art to replicate and implement the invention without undue experimentation.

### A. Implementation Details

Programming Languages: Python, Java, or Scala for backend development; JavaScript frameworks like React or Angular for frontend.

Machine Learning Libraries: TensorFlow, PyTorch, Scikit-learn for model development.

The machine learning categorization engine processes the data using pre-trained models. It comprises an application-specific integrated circuit (ASIC) for an artificial neural network connected to the computer memory device, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits.

In general, the machine learning algorithms in the present invention are used to make a prediction or classification based on some input data, which can be labeled or unlabeled. The algorithm will produce an estimate about a pattern in the data.

An error function evaluates the prediction of the model. If there are known examples, an error function can make a comparison to assess the accuracy of the model.

A model optimization process then occurs. If the model can fit better to the data points in the training set, then weights are adjusted to reduce the discrepancy between the known example and the model estimate. The algorithm will repeat this “evaluate and optimize” process, updating weights autonomously until a threshold of accuracy has been met.

Supervised learning in particular uses a training set to teach models to yield the desired output. This training dataset includes inputs and correct outputs, which enables the model to learn over time. The algorithm measures its accuracy through the loss function, adjusting until the error has been sufficiently minimized.

Thus, through the computer-implemented process described above, the present invention can improve its ability to predict and detect financial advisor performance.

Databases: MySQL or PostgreSQL for relational data; MongoDB or Cassandra for NoSQL databases.

Cloud Services: AWS, Azure, or Google Cloud Platform for infrastructure.

### B. Hardware Requirements

Servers: High-performance servers with multi-core processors and large RAM capacity.

Storage: SSDs for fast data access; scalable cloud storage solutions.

Networking: High-bandwidth connections for data transfer between components.

### XIII. Compliance with AI and ML Patent Requirements

### A. Detailed Algorithm Descriptions

Mathematical Formulations: Equations representing model algorithms, loss functions, optimization techniques (e.g., stochastic gradient descent).

Flowcharts: Diagrams illustrating data flow, decision points, and algorithmic processes.

### B. Training Processes

Data Splitting: Training, validation, and test datasets.

Hyperparameter Tuning: Processes for optimizing model parameters.

Regularization Techniques: Preventing overfitting using methods like dropout, L1/L2 regularization.

### C. Model Evaluation Metrics

Regression Metrics: Mean Squared Error (MSE), Root Mean Squared Error (RMSE), R-squared.

Classification Metrics: Accuracy, Precision, Recall, F1-score, ROC-AUC.

Cross-Validation: K-fold cross-validation for robust model assessment.

### D. Specific Use of AI Techniques

Explainable AI (XAI): Methods like SHAP values or LIME to interpret model predictions and ensure transparency.

Ethical AI Considerations: Bias detection and mitigation strategies in models to ensure fair evaluations.

### XIV. Industrial Applicability and Advantages

### A. Multi-Industry Application

Financial Services: Enhances compliance monitoring, risk management, and client advisory services.

Legal Services: Improves case outcome predictions, client satisfaction, and professional development.

Accounting: Assists in audit accuracy, compliance, and performance benchmarking.

Healthcare, Education, and Beyond: Adaptable to any industry requiring professional evaluations.

### B. Benefits

Objective Assessments: Reduces subjectivity by relying on quantifiable data and advanced analytics.

Personalization: Meets individual and organizational needs through adaptable evaluation criteria.

Efficiency: Automates data processing and analysis, saving time and resources.

Competitive Edge: Provides insights that help organizations improve services and outperform competitors.

Backend Processing and Adaptive AI Algorithm (Python with Flask)

A Python for backend calculations, such as processing responses, adapting questions, and calculating scores.

```
  from flask import Flask, request, jsonify
  import random
  app = Flask(_{——}name_{——})
  # Sample data for demonstration purposes
  fields = {
    “finance”: {
      “sections”: [“Client Engagement”, “Investment Evaluation”,
“Regulatory Compliance”]
    },
    “law”: {
      “sections”: [“Client Interaction”, “Case Management”,
“Professional Development”]
    }
  }
  # Define a sample adaptive question structure
  questions = {
    “finance”: {
      “Investment Evaluation”: [
        {“question”: “How frequently do you review client portfolios?”,
“weight”: 0.3},
        {“question”: “What diversification strategy do you employ?”,
“weight”: 0.2}
      ]
    },
    “law”: {
      “Case Management”: [
        {“question”: “How do you manage client cases?”, “weight”:
        0.4},
        {“question”: “What tools do you use for case tracking?”,
“weight”: 0.3}
      ]
    }
  }
  # Scoring function that calculates a weighted score based on responses
  def calculate_score(responses, field):
    total_score = 0
    total_weight = sum(q[“weight”] for sec in questions[field].values( )
for q in sec)
    for section, ans_list in responses.items( ):
      for i, answer in enumerate(ans_list):
        weight = questions[field][section][i][“weight”]
        total_score += answer * weight # Simplified score (0-1
response scale)
    return round(total_score / total_weight, 2) * 100
  @app.route(‘/select_field’, methods=[‘POST’])
  def select_field( ):
    data = request.json
    field = data.get(“field”)
    if field in fields:
      return jsonify({“message”: “Field selected”, “sections”:
      fields[field]
[“sections”]}), 200
    else:
      return jsonify({“message”: “Field not found”}), 404
  @app.route(‘/get_questions', methods=[‘POST’])
  def get_questions( ):
    data = request.json
    field = data.get(“field”)
    section = data.get(“section”)
    if field in questions and section in questions[field]:
      return jsonify({“questions”: questions[field][section]}), 200
    else:
      return jsonify({“message”: “Section or field not found”}), 404
  @app.route(‘/submit_responses', methods=[‘POST’])
  def submit_responses( ):
    data = request.json
    field = data.get(“field”)
    responses = data.get(“responses”)
    score = calculate_score(responses, field)
    return jsonify({“score”: score, “benchmark”: f“Compared to industry
average: {random.randint(70, 90)}%”}), 200
  if _{——}name_{——} == “_{——}main_{——}”:
    app.run(debug=True)
```

### 2. Frontend Interface (HTML/CSS and JavaScript)

For the user interface, JavaScript will manage interaction, send data to the backend, and display responses dynamically.

```
  <!DOCTYPE html>
  <html lang=″en″>
  <head>
    <meta charset=″UTF-8″>
    <title>Point93 BenchmarkEval System</title>
    <style>
      body { font-family: Arial, sans-serif; }
      .container { width: 60%; margin: auto; }
      .section { margin-bottom: 20px; }
    </style>
  </head>
  <body>
  <div class=″container″>
    <h1>Point93 BenchmarkEval System</h1>
    <div class=″section″>
      <label for=″field″>Select Field:</label>
      <select id=″field″ onchange=″selectField( )″>
        <option value=″finance″>Finance</option>
        <option value=″law″>Law</option>
      </select>
    </div>
    <div id=″questions″ class=″section″></div>
    <button onclick=″submitResponses( )″>Submit</button>
    <div id=″result″ class=″section″></div>
  </div>
  <script>
  async function selectField( ) {
    const field = document.getElementById(′field′).value;
    const response = await fetch(′/select_field′, {
      method: ′POST′,
      headers: { ′Content-Type′: ′application/json′ },
      body: JSON.stringify({ field })
    });
    const data = await response.json( );
    document.getElementById(′questions′).innerHTML = data.sections
      .map(section => ‘<button onclick=″getQuestions(′${section}′)″>$
{section}</button>‘).join(″);
  }
  async function getQuestions(section) {
    const field = document.getElementById(′field′).value;
    const response = await fetch(′/get_questions′, {
      method: ′POST′,
      headers: { ′Content-Type′: ′application/json′ },
      body: JSON.stringify({ field, section })
    });
    const data = await response.json( );
    document.getElementById(′questions′).innerHTML = data.questions
      .map(q => ‘<div>${q.question}: <input type=″number″ min=″0″
max=″1″ step=″0.1″></div>‘).join(″);
  }
  async function submitResponses( ) {
    const inputs = document.querySelectorAll(′#questions input′);
    const responses = Array.from(inputs).map(input =>
parseFloat(input.value));
    const field = document.getElementById(′field′).value;
    const response = await fetch(′/submit_responses′, {
      method: ′POST′,
      headers: { ′Content-Type′: ′application/json′ },
      body: JSON.stringify({ field, responses })
    });
    const data = await response.json( );
    document.getElementById(′result′).innerText = ‘Score:
    ${data.score}\n$
{data.benchmark}‘;
  }
  </script>
  </body>
  </html>
```

### 3. Database Structure (sql)

For scoring, storing questions, responses, and benchmarking data, a database schema in SQL might include:

```
CREATE TABLE fields (
  id INT PRIMARY KEY,
  name VARCHAR(50)
);
CREATE TABLE sections (
  id INT PRIMARY KEY,
  field_id INT,
  name VARCHAR(50),
  FOREIGN KEY (field_id) REFERENCES fields(id)
);
CREATE TABLE questions (
  id INT PRIMARY KEY,
  section_id INT,
  text VARCHAR(255),
  weight DECIMAL(3,2),
  FOREIGN KEY (section_id) REFERENCES sections(id)
);
CREATE TABLE responses (
  id INT PRIMARY KEY,
  question_id INT,
  response DECIMAL(3,2),
  FOREIGN KEY (question_id) REFERENCES questions(id)
);
CREATE TABLE benchmarks (
  id INT PRIMARY KEY,
  field_id INT,
  average_score DECIMAL(5,2),
  FOREIGN KEY (field_id) REFERENCES fields(id)
);
```

This setup provides a basic backend and frontend interaction, where questions are tailored based on fields and sections, and the scoring system adapts by calculating weighted responses and comparing scores against stored benchmarks. For production use, advanced handling, security protocols, and refined AI will be implemented to fully realize the system's capabilities.

Thus, the present invention presents a novel, technically advanced system for professional evaluation and benchmarking. By integrating an adaptive modular framework with sophisticated AI and machine learning algorithms, it addresses the limitations of prior art and meets the technical challenges of modern professional environments. The detailed disclosure ensures that skilled practitioners can implement the system, pushing the boundaries of personalized and objective professional assessments.

What is claimed is:

1. An adaptive modular system for professional evaluation and benchmarking across multiple industries, comprising:
a. a data ingestion layer configured to collect data from a plurality of sources, including internal databases, external databases, user inputs, and third-party application programming interfaces (APIs);
b. a data processing engine operatively connected to the data ingestion layer, the data processing engine configured to execute data cleaning by removing duplicates and correcting errors, perform data transformation by normalizing numerical data and encoding categorical variables, and integrate data from disparate sources into a structured format suitable for analysis;
c. a feature extraction module configured to extract and engineer features from the processed data, including performing dimensionality reduction using principal component analysis and selecting relevant features based on statistical significance tests and feature importance scores derived from machine learning models;
d. a machine learning module comprising a plurality of machine learning models, including supervised learning models for predictive assessments, unsupervised learning models for pattern detection and segmentation, deep learning models for complex pattern recognition in large datasets, and natural language processing models for analyzing textual data;
e. a plurality of evaluation modules, each evaluation module corresponding
to a specific assessment criterion and utilizing one or more of the machine learning models to perform assessments related to its specific criterion, wherein the evaluation modules include at least a financial performance module, a compliance module, a client satisfaction module, a professional development module, and a peer comparison module;
f. an adaptive algorithm controller configured to dynamically adjust evaluation criteria, model parameters, and weighting of the evaluation modules based on user inputs, preferences, and feedback, the adaptive algorithm controller employing reinforcement learning algorithms to optimize evaluation strategies over time;
g. a benchmarking database storing industry standards, peer performance data, and historical evaluation results, wherein the benchmarking database is utilized by the evaluation modules to provide comparative analysis;
h. a user interface layer configured to allow users to interact with the system, input preferences, adjust evaluation parameters, and view evaluation results through interactive visualization tools;
i. a security and compliance module configured to ensure data protection through encryption, access controls, and adherence to regulatory requirements;
j. wherein the system is configured to process data in real-time, providing personalized, objective, and continuously adapting professional evaluations, and to benchmark professional performance against current industry standards and peer data.

2. The system of claim 1, wherein the data ingestion layer further comprises:
a. application programming interfaces (APIs) and web scraping tools configured to extract data from third-party services and websites;
b. extract, transform, load (ETL) processes that include data validation checks to ensure data integrity during collection and ingestion.

3. The system of claim 1, wherein the data processing engine is further configured to handle missing values in the data using imputation techniques selected from the group consisting of mean substitution, median substitution, multiple imputation, and predictive modeling.

4. The system of claim 1, wherein the feature extraction module performs feature engineering by creating new features through mathematical transformations, aggregations, and combinations of existing data fields to enhance the predictive power of the machine learning models.

5. The system of claim 1, wherein the supervised learning models include:
a. regression models selected from the group consisting of linear regression, ridge regression, lasso regression, and elastic net regression for predicting continuous outcomes;
b. classification models selected from the group consisting of logistic regression, decision trees, random forests, support vector machines (SVM), and gradient boosting machines for predicting categorical outcomes.

6. The system of claim 1, wherein the unsupervised learning models include clustering algorithms selected from the group consisting of K-means clustering, hierarchical clustering, and density-based spatial clustering of applications with noise (DBSCAN) for grouping professionals based on performance metrics.

7. The system of claim 1, wherein the deep learning models comprise:
a. feedforward neural networks for general predictive modeling;
b. recurrent neural networks (RNNs) and long short-term memory (LSTM) networks for time-series analysis of performance data;
c. convolutional neural networks (CNNs) for processing and analyzing multi-dimensional data, if applicable.

8. The system of claim 1, wherein the natural language processing models are configured to:
a. perform text classification using algorithms such as Naïve Bayes, support vector machines, or transformer-based models;
b. conduct sentiment analysis using lexicon-based approaches or pre-trained models such as BERT or GPT;
c. execute topic modeling using methods like latent Dirichlet allocation (LDA) to identify thematic structures within textual data.

9. The system of claim 1, wherein the adaptive algorithm controller employs reinforcement learning techniques selected from the group consisting of Q-learning, deep Q-networks (DQN), and policy gradient methods to adjust evaluation strategies based on user interactions and feedback.

10. The system of claim 1, wherein each evaluation module further comprises:
a. specific algorithms and metrics tailored to its assessment criterion,
including:
i. for the financial performance module: time-series forecasting models, risk-adjusted return calculations, and financial ratio analysis;
ii. for the compliance module: rule-based systems and anomaly detection algorithms to monitor adherence to regulatory standards;
iii. for the client satisfaction module: sentiment analysis of client feedback, churn prediction models, and customer lifetime value assessments;
iv. for the professional development module: competency mapping using knowledge graphs, skill gap analysis, and tracking of certification achievements;
v. for the peer comparison module: statistical analysis and ranking algorithms to benchmark performance against peers within the benchmarking database.

11. The system of claim 1, wherein real-time data processing and analysis are achieved through:
a. parallel processing techniques utilizing multi-threading and multi-processing;
b. distributed computing frameworks selected from the group consisting of Apache Hadoop, Apache Spark, and Apache Flink to handle big data workloads and streaming data;
c. in-memory computing to accelerate data access and computation.

12. The system of claim 1, wherein the user interface layer provides:
a. an interactive web-based dashboard with visualization tools implemented using JavaScript libraries such as D3.js, Chart.js, or Plotly, enabling dynamic data representation through charts, graphs, and tables;
b. functionality for users to input preferences, adjust evaluation parameters, and customize the weighting of evaluation modules;
c. reporting features that generate evaluation reports in various formats, including PDF and Excel, and the ability to set up alerts and notifications delivered via email, SMS, or in-app messages.

13. The system of claim 1, wherein the benchmarking database employs:
a. structured query language (SQL) databases for relational data storage and retrieval;
b. NoSQL databases such as MongoDB or Cassandra for storing unstructured data;
c. query optimization techniques, indexing, and caching mechanisms to enhance data retrieval performance;
d. application programming interfaces (APIs) to expose data retrieval functions for internal and external use.

14. The system of claim 1, wherein the security and compliance module includes:
a. data encryption methods using Advanced Encryption Standard (AES) with 256-bit keys for data at rest and Transport Layer Security (TLS) or Secure Sockets Layer (SSL) protocols for data in transit;
b. access control mechanisms implementing role-based access control (RBAC) and multi-factor authentication (MFA) to restrict unauthorized access;
c. compliance features to adhere to data protection regulations such as the General Data Protection Regulation (GDPR), the Health Insurance Portability and Accountability Act (HIPAA), and industry-specific regulatory requirements;
d. audit logging and monitoring capabilities to track system usage and detect potential security breaches.

15. The system of claim 1, wherein the machine learning module further incorporates:
a. model training processes that include splitting data into training, validation, and test sets to evaluate model performance accurately;
b. hyperparameter tuning methods such as grid search, random search, or Bayesian optimization to optimize model parameters;
c. regularization techniques including L1 regularization (Lasso), L2 regularization (Ridge), and dropout to prevent overfitting and enhance model generalization;
d. cross-validation techniques, including k-fold cross-validation, to ensure the robustness of the machine learning models.

16. The system of claim 1, wherein the adaptive algorithm controller further utilizes feedback mechanisms comprising:
a. explicit feedback collected directly from user ratings and input regarding the relevance and accuracy of evaluation results;
b. implicit feedback inferred from user interactions with the system, such as time spent viewing certain evaluation modules, navigation patterns, and usage frequency;
c. preference learning algorithms to model and predict user preferences over time, enabling the system to personalize evaluations effectively.

17. The system of claim 1, further comprising explainable AI (XAI) components configured to:
a. provide transparency and interpretability of machine learning model predictions through techniques such as SHapley Additive exPlanations (SHAP) values, Local Interpretable Model-agnostic Explanations (LIME), or counterfactual explanations;
b. generate human-readable explanations for evaluation results, aiding users in understanding the factors influencing their assessments;
c. detect and mitigate biases within the machine learning models to ensure fairness and ethical AI practices.

18. A method for providing adaptive, personalized professional evaluations and benchmarking using the system of claim 1, the method comprising:
a. collecting data from multiple sources via the data ingestion layer;
b. processing and transforming the collected data using the data processing engine into formats suitable for analysis;
c. extracting and engineering features from the processed data using the feature extraction module;
d. training the plurality of machine learning models within the machine learning module using the extracted features;
e. configuring the plurality of evaluation modules with the trained machine learning models to assess specific criteria;
f. dynamically adjusting evaluation criteria, model parameters, and module weightings using the adaptive algorithm controller based on user inputs, preferences, and feedback;
g. utilizing the benchmarking database to compare individual professional performance against industry standards and peer data;
h. presenting the evaluation results to users via the user interface layer, allowing users to interact with the system, provide feedback, and adjust evaluation parameters;
i. updating the machine learning models and evaluation strategies over time through continuous learning and adaptation based on accumulated data and user interactions.

19. The method of claim 18, further comprising:
a. implementing real-time data processing by utilizing distributed computing frameworks and in-memory computing to handle streaming data inputs and provide instantaneous evaluation updates;
b. employing natural language processing models to analyze unstructured textual data, enhancing the comprehensiveness of evaluations by incorporating qualitative information;
c. integrating security measures throughout the data processing pipeline to protect sensitive information and ensure compliance with relevant data protection regulations.

20. An application-specific integrated circuit (ASIC) for an artificial neural network connected to the computer memory device, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits; and wherein the ASIC is configured to benchmark professional performance against current industry standards and peer data
